(19) United States
(12) Patent Application Publication
(10) Pub. No.: US 2025/0113224 A1
(43) Pub. Date: Apr. 3, 2025

(54) MULTI-LAYER INTERFERENCE DETECTION IN A MOBILE WIRELESS INFRASTRUCTURE

(71) Applicant: Apple Inc., Cupertino, CA (US)

(72) Inventors: Debarshi Kar, Sunnyvale, CA (US); Daniel R. Borges, San Francisco, CA (US); Nathan J. Zhao, San Jose, CA (US); Nohee Ko, Mountain View, CA (US)

(73) Assignee: Apple Inc., Cupertino, CA (US)

(21) Appl. No.: 18/894,857

(22) Filed: Sep. 24, 2024

Related U.S. Application Data
(60) Provisional application No. 63/541,242, filed on Sep. 28, 2023.

(51) Int. Cl. H04W 24/08; H04B 17/309; H04L 43/0829; H04W 40/16

(52) U.S. Cl. CPC H04W 24/08; H04B 17/346; H04L 43/0829; H04W 40/16

(57) ABSTRACT

Techniques are described for multi-layer interference detection. The method can include transmitting data to a system using a connection on a wireless network, the system configured to provide access to a functionality of a device. The method can further include accessing at least one of link quality monitoring (LQM) information from a medium access control layer of the user device or transmission control protocol (TCP) information from a transport layer of the device during a presentation of data by the system. The method can further include determining that the wireless network is experiencing interference based at least in part on the LQM information or TCP information. The method can further include generating interference information based at least in part on determining that the wireless network is experiencing the interference. The method can further include transmitting the interference information to the system during the presentation of data by the system.

### CROSS-REFERENCES TO RELATED APPLICATIONS

This application claims the benefit of U.S. Provisional Application No. 63/541,242, filed on Sep. 28, 2023, which is incorporated by reference.

### BACKGROUND

Wireless technology enables the transfer of data without the need for physical wires or cables. From wireless internet connections and mobile communication networks to Bluetooth devices and smart home systems, wireless technology has seamlessly integrated into various aspects of people's lives. Continuous advancements and expanding applications in wireless technology help shape the interconnected world with seamless device connectivity.

### BRIEF DESCRIPTION OF THE DRAWINGS

FIG. 1 is an illustration of an example multi-layer detection system, according to one or more embodiments.

FIG. 2 is an illustration of an example multi-layer detection system, according to one or more embodiments.

FIG. 3 is an illustration of an example basic service set (BSS) for multi-layer interference detection, according to one or more embodiments.

FIG. 4 is an illustration of an example user device in communication with an infotainment system, according to one or more embodiments.

FIG. 5 is an illustration of an example logic diagram for a multi-layer detection system, according to one or more embodiments.

FIG. 6 is an example signaling diagram for a multi-layer detection system, according to one or more embodiments.

FIG. 7 is an illustration of example messaging for a multi-layer detection system, according to one or more embodiments.

FIG. 8 is an illustration of an example alternate path, according to one or more embodiments.

FIG. 9 is an illustration of an example alternate path switch back process, according to one or more embodiments.

FIG. 10 is an illustration of an example user device in communication with an AP, according to one or more embodiments.

FIG. 11 is an illustration of an example alternate path switch back process, according to one or more embodiments.

FIG. 12 is an illustration of an example user device in communication with an AP, according to one or more embodiments.

FIG. 13 is an illustration of an example alternate path switch back process, according to one or more embodiments.

FIG. 14 is an illustration of an example alternate path, according to one or more embodiments.

FIG. 15 is an illustration of an example alternate path switch back process, according to one or more embodiments.

FIG. 16 is an illustration of an example of a vehicle encountering an interference signal, according to one or more embodiments.

FIG. 17 is an example process flow for detecting an interference signal, according to one or more embodiments.

FIG. 18 is an example process flow for detecting an interference signal, according to one or more embodiments.

FIG. 19 is an example process flow for transmitting interference information, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A user device can communicate with a separate device, e.g., an infotainment system, over unlicensed bands. However, other technologies can also operate using these unlicensed bands. These other technologies can emit signals that cause interference with communication between the user device and the separate device. The interference can come from signals that cause distortion of the waves transmitted between the user device and the separate device. In real-world scenarios, these transmitters can be used by, for example, airports and traffic security cameras. The transmitter can cause interference by having a jammer-like effect for any nearby user device that is using the same channel for communication as the interference signal. The effect can be distortion and disruption of any content being transmitted by the user device, e.g., for presentation on the infotainment system.

Another source of interference can be from nearby vehicles that include devices that are also using the same channel as the user device for communication. For example, at intersections that experience heavy traffic, the devices inside each vehicle can create interference for the devices in other vehicles.

Each of the above examples describes sources of interference that can decrease the user's experience, such as while using their infotainment system to present content from their user device. For example, a user can wirelessly connect their user device (e.g., a smartphone, such as an iPhone) to a vehicle system (e.g., an infotainment system (or head unit) that includes Apple CarPlay, Android Auto, Mirror Link) to stream audio (e.g., Apple Music, Spotify, podcasts, etc.). In some instances, the vehicle system can be impacted by an interference signal, and the communication between the vehicle system and the user device can be adversely affected, such that the experience is diminished (e.g., sound quality diminished, content skips, content discontinues, or the like).

Embodiments described herein address the above-referenced issues by providing techniques for a multi-layer detection system to detect the onset or presence of interference from an external source. The multi-layer detection system can be configured to detect signals using multiple network stack layers, in which different layers can be configured to detect different information that can be used to determine whether the network connecting the user device and the vehicle system is experiencing interference.

If the multi-layer detection system determines that the network connecting the user device and the vehicle system is experiencing interference, it can effectuate a process to change the communication path (or link) between the user device and the vehicle system to mitigate or reduce the interference. The multi-layer detection system can continue to monitor the signals from external sources after effectuating the process. In the event that the multi-layer detection system determines that the network connecting the user device and the vehicle system is no longer experiencing interference, it can switch back to using the original communication path. While embodiments are presented in the context of a vehicle system (e.g., an infotainment system), the techniques can be applied in communication between any devices that are communicating wirelessly.

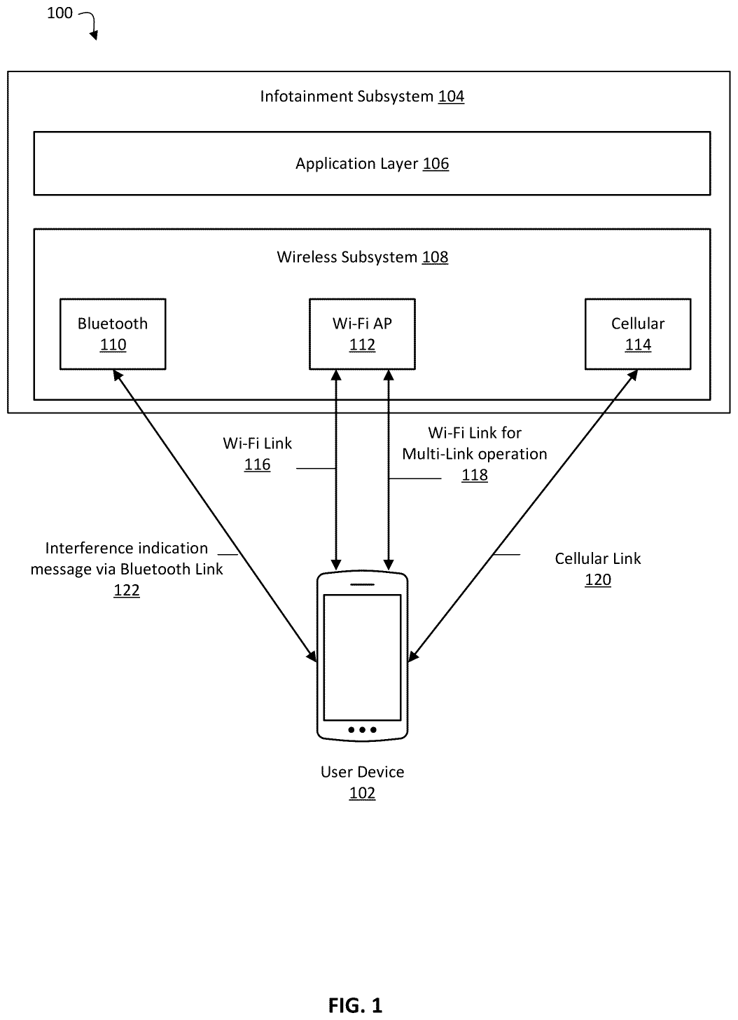

FIG. 1 is an illustration 100 of an example multi-layer detection system, according to one or more embodiments. As illustrated, a user device 102 (e.g., smartphone, tablet, laptop) can be in communication with an infotainment subsystem 104 of an infotainment system. In other embodiments, the user device 102 can communicate with a different vehicle system or a different type of device. The infotainment subsystem 104 can include an application layer 106, such as for Apple CarPlay, Android Auto, Mirror Link, or other similar software. The infotainment subsystem 104 can include a wireless subsystem 108. The wireless subsystem 108 can include a Bluetooth unit 110 for managing communications that use a Bluetooth protocol, a Wi-Fi access point (AP) 112 for managing communications that use a Wi-Fi protocol, and a cellular unit 114 for managing communications that use a cellular protocol. For example, a user device functionality (such as an application or service that supports media streaming, full or partial device mirroring, application extension, etc.) can transmit to and receive from the Wi-Fi AP 112 via a Wi-Fi link 116.

The infotainment subsystem 104 can communicate with the user device 102 using one or more links. For example, in a multi-link operation, the user device 102 can transmit to and receive from the Wi-Fi AP 112 via a Wi-Fi link for a multi-link operation 118 in addition to the Wi-Fi link 116. The user device 102 can also transmit to and receive from the cellular unit 114 via a cellular link 120. The user device 102 can also transmit to and receive from the Bluetooth unit 110 via a Bluetooth link.

In some instances, an external signal can create interference for one or more of the Wi-Fi link 116, the Wi-Fi link for multi-link operation 118 and/or the cellular link 120. This interference can affect the quality of the signals being transmitted to and from the user device 102. In response, the user device 102 can transmit interference information via Bluetooth link 122 to the wireless subsystem 108. Embodiments herein provide techniques to detect the onset of signal interference and to adjust a communication path between the user device 102 and the infotainment subsystem 104 to reduce any interference. As described below, based on the interference information via Bluetooth link 122, the infotainment subsystem 104 can adjust a communication path to reduce any interference from the external signal.

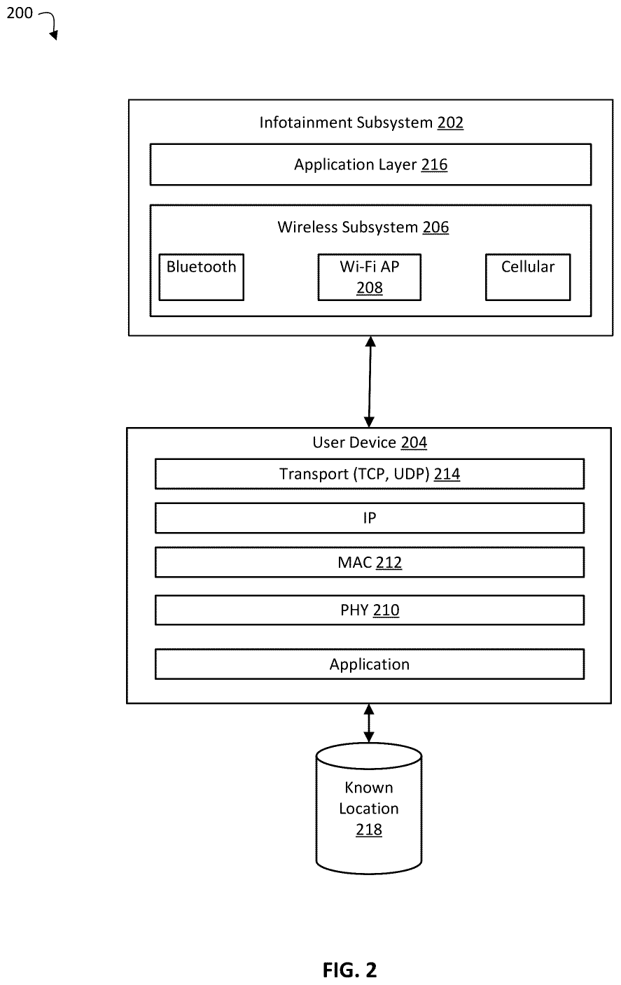

FIG. 2 is an illustration of an example multi-layer detection system 200, according to one or more embodiments. The multi-layer detection system 200 can be configured to use a hybrid approach that utilizes both a vehicle's infotainment subsystem 202 and a user device 204 to monitor information. The multi-layer detection system 200 can use the hybrid approach to prevent interference signals that are not identified by the infotainment subsystem 202 but are identified by the user device 204, and vice versa. For example, a Wi-Fi AP 208 of the infotainment subsystem 202 can be configured to monitor for one or more Wi-Fi frame and/or subframe types that may cause, or otherwise be associated with, interference. For example, the Wi-Fi AP 208 can be configured to monitor for a Wi-Fi subframe type 14 and/or 15. The Wi-Fi AP 208 can monitor for the one or more Wi-Fi frame and/or subframe types at a physical layer (PHY) and/or a medium access control layer (MAC) of the AP's network stack. The PHY can be responsible for transmitting data over a physical network. The MAC can be a sublayer within a datalink layer that is responsible for providing communication services to devices on the same physical network (e.g., a user device and an infotainment system). The multi-layer detection system 200 can monitor for interference signals using the wireless subsystem 206 of the infotainment subsystem 202, including an antenna for transmitting and receiving using various transmission protocols, such as cellular, Wi-Fi, and Bluetooth. In some implementations, the wireless subsystem 206 of the infotainment subsystem 202 can be integrated into a vehicle's dashboard system to enable the infotainment system to wirelessly communicate with the user device 204.

The Wi-Fi AP 208 can be integrated with various hardware and/or software elements, such as a protocol analyzer or a packet sniffer. The hardware and/or software can be used to analyze one or more data packets in network traffic. One or more frame types are associated with, or otherwise indicative of, signals that can cause interference in communication between a user device and an infotainment system. An example of a frame type associated with interference is a Wi-Fi subframe type 14 or 15. Wi-Fi subframe type 14 can be a management frame used for a beacon frame and Wi-Fi subframe type 15 can be a management frame used for a probe response frame. The Wi-Fi AP 208 can monitor for one or more types of frames that can be indicative of a signal that causes interference at the PHY 210 and MAC 212. It should be appreciated that one or more frame types other than Wi-Fi subframe type 14 or 15 can be indicative of a signal that can cause interference. The Wi-Fi AP 208 can be configured to monitor for any frame and/or subframe types or other signals that are associated with potential interference, including signaling associated with any/all of Wi-Fi, cellular, ultra-wideband, and/or Bluetooth.

Not all interference signals may be identifiable by particular frame and/or subframe types. Therefore, the multi-layer detection system 200 can also use a user device 204 to monitor for an interference signal, e.g., at the PHY 210 and/or MAC 212 of a network stack of the user device 204. For example, the client application can perform link quality monitoring (LQM) to measure the quality of a communication link between the user device 204 and the Wi-Fi AP 208. In general, LQM measures any of signal strength, noise level, and other appropriate metrics, and uses the one or more measurements to calculate an LQM score. The LQM score value can be indicative of the quality of a communication link, e.g., between the user device 204 and the Wi-Fi AP 208. For example, the user device 204 can compare the LQM score to a threshold score and determine whether the comparison indicates the presence of an interference signal.

The user device 204 can also monitor for an interference signal at a transport layer 214, e.g., using the client application. The transport layer 214 can be responsible for managing traffic between devices (e.g., the Wi-Fi AP 208 and the user device 204). For example, the transport layer 214 can implement a transmission control protocol (TCP) for managing the exchange of data between the devices. At the transport layer 214, the user device 204 can monitor the number of TCP retransmissions occurring within a particular time interval. A TCP retransmission can occur if the transmission of data is not acknowledged by a receiving device prior to the expiration of a timer. In this instance, a transmitting device can retransmit the data to ensure that the data is received by the receiving device. For example, the user device 204 can start a timer and transmit data packet(s) to the infotainment system via the Wi-Fi AP 208 and not receive an acknowledgement (ACK) of the data prior to the expiration of the timer. The user device 204 can retransmit the data packets to the infotainment system via the Wi-Fi AP 208 to ensure that the data packets are received. The frequency with which data packets are retransmitted can be indicative of interference with the signal between the user device 204 and the Wi-Fi AP 208.

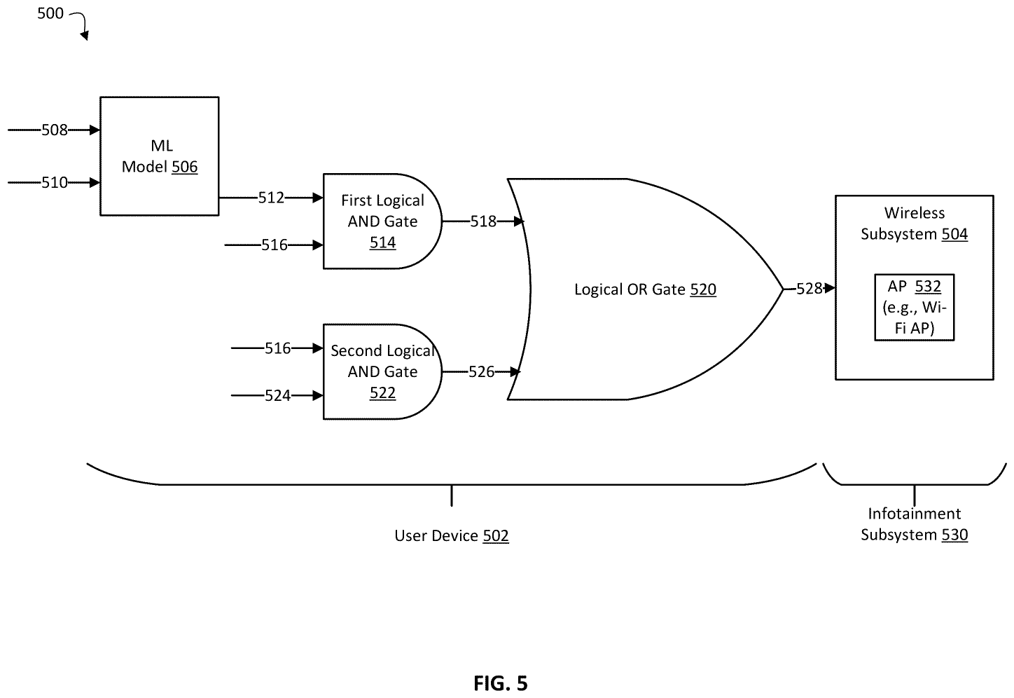

The infotainment subsystem 202 can monitor for an interference signal at an application layer 216. The application layer 216 can include protocols that can be used for communication. The user device 204 can monitor for a set of application specific keep-alive timeouts that occur during a particular time interval. A keep-alive can be part of the HTTP protocol and the keep-alive header can allow multiple requests to be sent, e.g., from the user device 204 to the application layer 216 of the infotainment subsystem 202 via the Wi-Fi AP 208 over a single connection rather than over multiple connections. The keep-alive timeout maintains the connection between the Wi-Fi AP 208 and the user device 204, even after the transmitting device has stopped transmitting requests. If the application layer 216 determines that there is an indication of an interference signal based on the keep-alive timeout information, the application layer 216 can generate a flag signal. The flag signal is described further with respect to FIG. 5.

The user device 204 can further access a database 218 of known locations of interference zones or areas. The user device 204 can further access a location service (e.g., a global positioning system service) to determine (e.g., continuously, periodically, or in response to a trigger) a current location of the user device 204. The user device 204 can compare the current location of the user device 204 with one or more known locations of interference zones stored in the database 220 to determine if the user device 204 is in an interference zone or within a threshold distance of an interference zone.

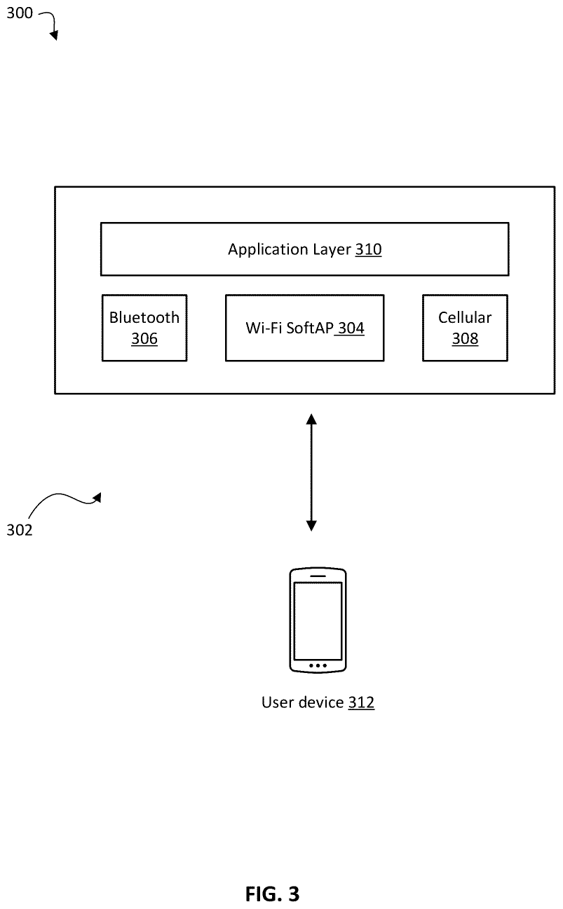

FIG. 3 is an illustration 300 of a basic service set (BSS) 302 for multi-layer interference detection, according to one or more embodiments. The BSS 302 can include a network topology for allowing a wireless device to communicate with another wireless device using a common medium. As illustrated, the BSS 302 can include a Wi-Fi software enabled AP 304 (e.g., Wi-Fi SoftAP), which is software that enables a device to act as a wireless router and provide wireless coverage to the user device 312. The BSS 302 can further include a Bluetooth unit 306 and a cellular unit 308, which together with the Wi-Fi SoftAP 304 can form a wireless subsystem. The BSS 302 can further include an application layer 310.

As indicated above, an interference signal can adversely affect the signal quality between the Wi-Fi SoftAP 304 and the user device 312. The Wi-Fi SoftAP 304 and the user device 312 can work in tandem to detect an interference signal. In the event that an interference signal is detected, the Wi-Fi SoftAP 304 and the user device 312 can, as described below, adjust one or more of the communication path parameters to mitigate (or reduce) loss in signal quality.

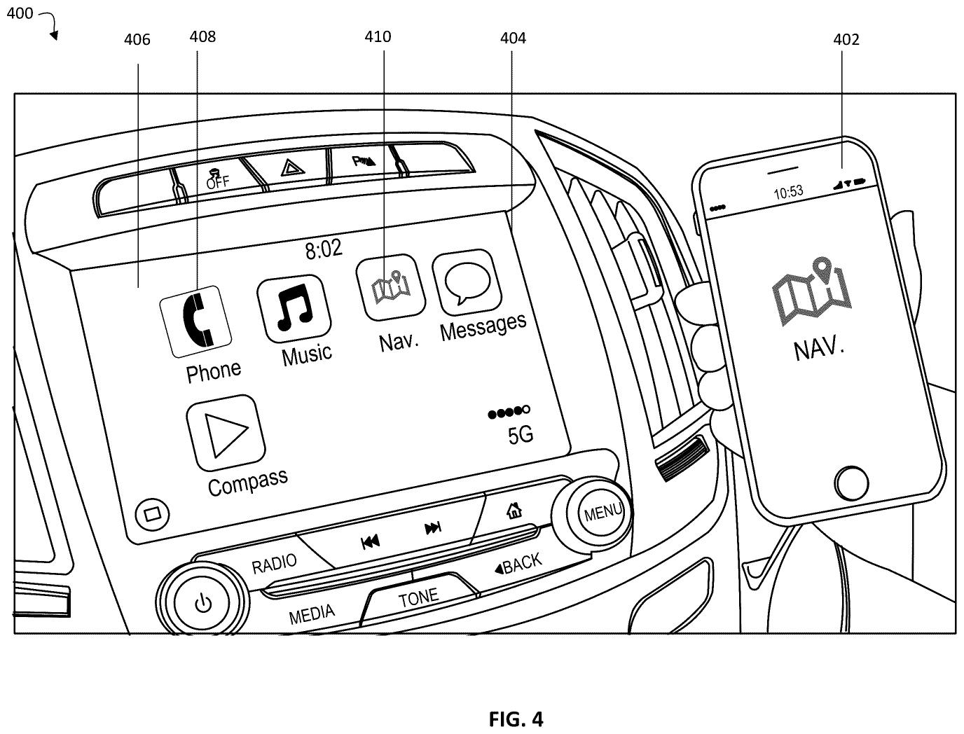

FIG. 4 is an illustration 400 of an example user device in communication with an infotainment system, according to one or more embodiments. As illustrated, a user device 402 is in wireless connection with an infotainment system 404 via an AP. The infotainment system 404 can include technology (e.g., Apple CarPlay, Android Auto, Mirror Link, or other similar technology) that permits the user device 402 to integrate with, or otherwise extend functionality to, the infotainment system 404. For example, the technology can enable functionality (e.g., one or more apps, features, etc.) of the user device 402 to be accessed at the infotainment system 404.

As seen, the infotainment system 404 can include a display 406, and once the user device 402 is connected via the technology, one or more icons (e.g., a phone icon 408, a navigation services icon 410, or other icon) that are generally displayed on the user device 402 can be displayed on the infotainment system 404. The user can access a navigation service associated with the user device 402 by engaging the navigation service icon 410 on the display 406 of the infotainment system 404. The navigation service can, for example, transmit high resolution video frames (e.g., at 60 frames per second (60 fps)) to the infotainment system 404, e.g., for display. In some infotainment systems with multiple screens, the throughput can be higher (e.g., reaching or exceeding one hundred megabytes per second (100 Mbps)). An interference signal can affect the communication between the user device 402 and the infotainment system 404, and diminish user experience (e.g., poor sound quality for a music application, reduced fps, or other diminishment in service). The herein described multi-layer detection system can assist with detecting interference, e.g., an aggressor signal, before the interference signal noticeably degrades the signal quality and with reconfiguring the connectivity between the user device 402 and the infotainment system 404 to maintain the strong signal quality and user experience.

FIG. 5 is an illustration 500 of an example logic diagram for a multi-layer detection system, according to one or more embodiments. The user device 502 can be configured to use one or more secondary signals to build a model to assist interference signal detection. In the instance that the user device 502 determines the presence of an interference signal, the user device 502 can be configured to transmit interference information to the wireless subsystem 504 (e.g., wireless subsystem 108) of an infotainment subsystem 530 (e.g., infotainment subsystem 104).

The user device 502 can include a machine learning (ML) model 506 that is trained to receive one or more inputs and predict whether there is an interference signal based on the inputs. The inputs can include one or more LQM measurements 508. For example, the user device 502 can take one or more LQM measurements 508 via the PHY/MAC of the device's network stack. The one or more LQM measurements 508 can be received by the ML model 506 as a first input. In some implementations, the ML model's inputs can also include one or more TCP statistics 510. For example, the user device 502 can use the transport layer of the device's network stack to detect one or more TCP statistics 510 (e.g., TCP retransmissions over a time interval). The one or more TCP statistics 510 can be received by the ML model 506 as a second input. In some implementations, additional and/or different inputs also can be received by the ML model 506.

The ML model 506 can be configured to use the input(s), e.g., the LQM measurements 508 and the TCP statistics 510, to output an ML model prediction 512. The ML model prediction 512 can be an indication of the presence of an interference signal or an indication of no interference signal. In the event that the ML model 506 predicts the presence of an interference signal, e.g., based on the LQM measurements 508 and the TCP statistics 510, the ML model prediction 512 can be indicated as a flag (FLAG_NETWORK_STATS). In the event the ML model 506 does not predict an interference signal, the ML model prediction 512 can be indicated as a null signal (e.g., a signal indicating no interference signal).

The ML model 506 can receive inputs continuously, periodically, or in response to a trigger. The ML model 506 also can generate an ML prediction continuously, periodically, or in response to a trigger. In some instances, the ML model prediction 512 can be a continuous or semi-continuous (e.g., in accordance with an on-going frequency) output based on the received one or more LQM measurements 508 and/or the one or more TCP statistics 510. The ML model 506 can continuously or semi-continuously receive one or more real-time LQM measurements 508 and/or TCP statistics. In response to the inputs, the ML model 506 can continuously or semi-continuously output a real-time prediction. For example, it is possible that at a first point in time, t1, the one or more LQM measurements 508 and/or TCP statistics 510 monitored by the user device (e.g., while in an interference zone) are indicative of the presence of an interference signal. Therefore, the ML model 506 can output a flag as the ML model prediction 512. The flag can continue to be asserted as long as the ML model prediction 512 indicates the presence of an interference signal. It is also possible that at a subsequent point in time, t2, the one or more LQM measurements 508 and/or TCP statistics 510 monitored by the user device are not indicative of the presence of an interference signal. Therefore, the ML model 506 can output a null signal as the ML model prediction 512.

The ML model prediction 512 can be received as a first input by a first logical AND gate 514. The first logical AND gate 514 can also receive a keep-alive statistics input (FLAG_CARPLAY_KEEPALIVE) 516. The keep-alive statistics input 516 can indicate that the user device 502 and the AP are experiencing interference based on a number of keep-alive timeouts that occurred over a time interval. For example, an application layer (e.g., Apple CarPlay, Android Auto, Mirror Link, or other software) can collect the keep-alive statistics. The application layer can use one or more keep-alive statistics, such as the keep-alive timeouts that occurred over a time interval, to determine whether there is an indication that the connection between the AP and the user device 502 is experiencing interference.

The first logical AND gate 514 can receive the ML model prediction 512 as it is generated (e.g., continuously, semi-continuously, periodically, etc.) as well as the keep-alive statistics input 516 and generate an output 518 at a similar rate (e.g., continuously, semi-continuously, periodically, etc.). If both the ML model prediction 512 and the keep-alive statistics input 516 indicate that the connection between the user device 502 and the AP is experiencing interference, then the first logical AND gate output 518 can be a signal (e.g., a logical 1) indicating the presence of interference on the connection between user device 502 and the AP. If either the ML model prediction 512 or the keep-alive statistics input 516 do not indicate that the connection between the user device 502 and the AP is experiencing interference, then the first logical AND gate output 518 can be a signal (e.g., a logical 0) indicating that the connection between user device 502 and the AP is not experiencing interference. In either case, the first logical AND gate output 518 can be received by a logical OR gate 520.

The logical OR gate 520 can also receive an output from a second logical AND gate 522. The second logical AND gate 522 can also receive the keep-alive statistics input 516. For example, the application layer can transmit the keep-alive statistics input 516 to be received by both the first logical AND gate 514 and the second logical AND gate 522, respectively. In addition, the second logical AND gate 522 can also receive a known interference zone input 524. For example, a processor of the user device 502 can access a database of known interference zones (or areas) and compare the known interference zones with the location of the user device 502. When the user device 502 is within a threshold distance of a known interference zone, the user device 502 can infer that the location information indicates that the connection between the user device 502 and the AP is experiencing interference. The processor can transmit a known interference zone input 524 in the form of a flag signal (FLAG_INTERFERENCE_LOC) to the second logical AND gate 522. The flag signal can be, for example, a logical 1 when the user device 502 location corresponds to a known interference zone. When the user device 502 is not within a threshold distance of a known interference zone, the user device 502 can infer that the location information does not indicate that the connection between the user device 502 and the AP is experiencing interference. The processor can transmit a known interference zone input 524 in the form of a null signal to the second logical AND gate 522. The null signal can be, for example, a logical 0 when the user device 502 location does not correspond to a known interference zone.

The second logical AND gate 522 can transmit an output based on a combination of the keep-alive statistics input 516 and the known interference zone input 524. If both the keep-alive statistics input 516 and the known interference zone input 524 indicate that the connection between the user device 502 and the infotainment subsystem 530 is experiencing interference, then the second logical AND gate 522 can transmit a second logical AND gate output 526 (e.g., a logical 1) indicating that the connection is (or may be) experiencing interference. If either the keep-alive statistics input 516 or the known interference zone input 524 do not indicate that the connection is experiencing interference, then the second logical AND gate 522 can transmit a second logical AND gate output 526 (e.g., a logical 0) that indicates that the connection is not experiencing interference.

The logical OR gate 520 can receive the first logical AND gate output 518 and the second logical AND gate output 526, and transmit a logical OR gate output 528 based on either the first logical AND gate output 518 or the second logical AND gate output 526. If either the first logical AND gate output 518 or the second logical AND gate output 526 indicates that the connection is experiencing interference, the logical OR gate output 528 can be interference information (e.g., a logical 1) indicating the presence (or potential presence) of interference. If, however, both the first logical AND gate output 518 and the second logical AND gate output 526 indicate that the connection is not experiencing interference, then the logical OR gate output 528 can be a null signal (e.g., a logical 0) indicating the absence (or potential absence) of interference.

The user device 502 can detect that the logical OR gate output 528 is information that is indicative of interference, or the likelihood/possibility thereof, based on the value. As the connection may be experiencing interference, the user device can change one or more settings. For example, the user device 502 can switch transmission protocols to transmit the interference information to the AP 532 of the wireless subsystem 504. The user device 502 can switch from using Wi-Fi to one or more other transmission protocols, such as near field communication, ultra-wideband communication, Bluetooth, or cellular, to transmit the interference information. In this sense, even though the interference signal may be hindering Wi-Fi communication, the user device 502 can still transmit the interference information to the AP 532 of the wireless subsystem 504.

The logical OR gate output 528 can be received by the wireless subsystem 504 and propagated to the AP 532, and the AP 532 can perform one or more appropriate operations to mitigate (or reduce) the effects of any interference. For example, if the logical OR gate output 528 is interference information, the AP 532 can adjust one or more communication parameters being used by the user device 502 and/or the AP 532. If the logical OR gate output 528 is not information that is indicative of interference, then the AP 532 can maintain the communication parameters being used by the user device 502 and the AP 532.

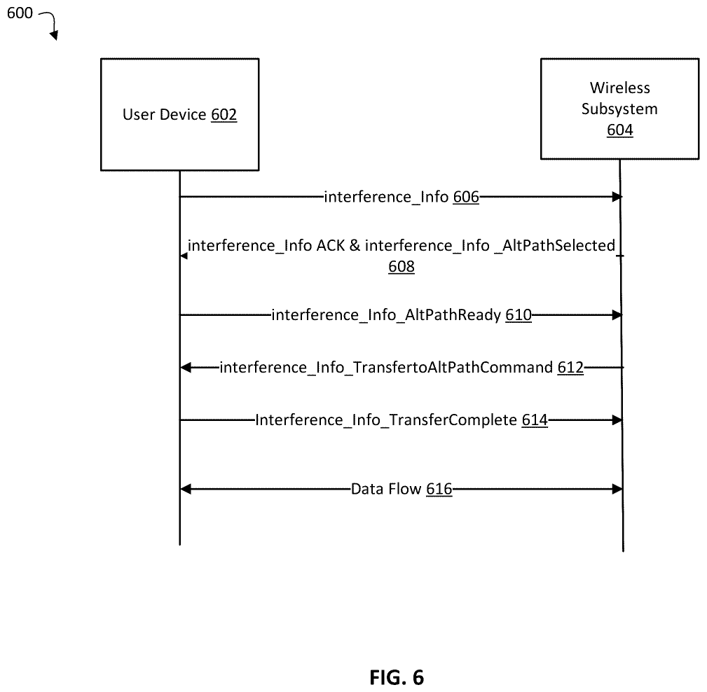

FIG. 6 is an example signaling diagram 600 for a multi-layer detection system, according to one or more embodiments. As illustrated, a user device 602 can be in communication with a wireless subsystem 604. While the operations of processes 600, 1700, 1800, and 1900, are described as being performed by generic computers, it should be understood that any suitable device may be used to perform one or more operations of these processes. Processes 600, 1700, 1800, and 1900 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform functions or implement data types. The order in which the operations are described is not intended to be construed as a limitation, and any number of the described operations can be combined in any order and/or in parallel to implement the processes.

At 606, the user device 602 can transmit a message, such as an interference information message (interference_Info) including interference information, to the wireless subsystem 604 of the infotainment system. For example, as indicated in FIG. 5, the user device can receive and process information through a set of logic gates. Based on the processing, the user device 602 can determine that the connection between user device 602 and the wireless subsystem 604 is experiencing interference. The user device 602 can switch from a first transmission protocol to a second transmission protocol (e.g., Wi-Fi to Bluetooth) and further transmit the interference information to the wireless subsystem of the infotainment system using the second transmission protocol.

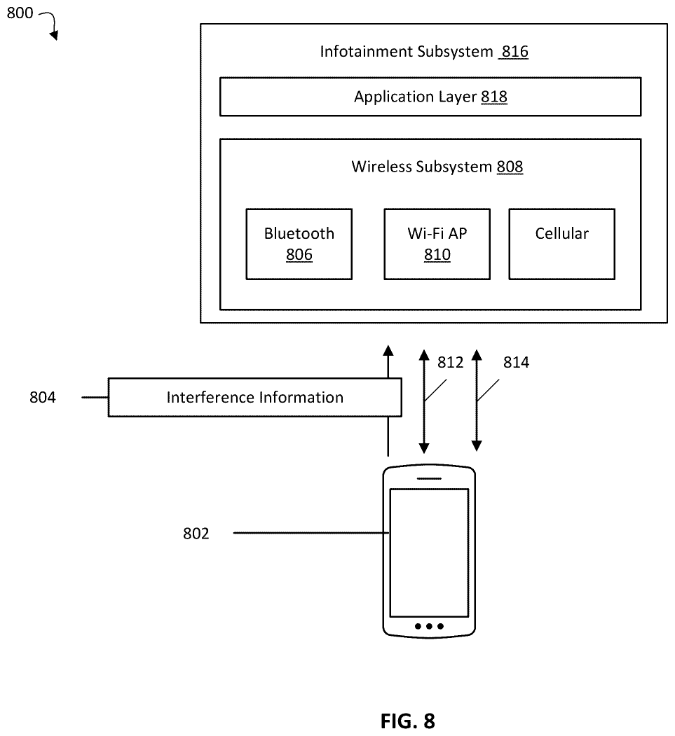

At 608, the wireless subsystem 604 can transmit a message (interference ACK) to the user device 602 that includes an acknowledgment (ACK) of the interference information and an identification of an alternate communication path (interference_AltPathSelected) between the user device 602 and the wireless subsystem 604 of the infotainment system. Examples of alternate communication paths are described with more particularity with respect to FIGS. 8-13. The alternate communication path can further permit a strong communication signal between the user device 602 and the wireless subsystem 604 via the wireless subsystem 604 link, e.g., while the user device 602 and the wireless subsystem 604 are in an interference zone.

At 610, the user device 602 can transmit a message (interference_AltPathReady) to the wireless subsystem 604 that the alternate path is ready. For example, the user device 602 can adjust one or more communication parameters to be compatible with the alternate path. The user device 602 can transmit the interference_AltPathReady message to the wireless subsystem of the infotainment system based on completing the communication parameter adjustments.

At 612, the wireless subsystem 604 can transmit a message (interference_TransfertoAltPathCommand), including one or more control instructions to transfer communication to the alternate path.

At 614, the user device 602 can transmit a message (interference_TransferComplete), indicating that the user device 602 has transferred communication to the alternate path. The user device 602 can transmit and receive data packets from the wireless subsystem 604 over the alternate path.

At 616, the user device 602 and the wireless subsystem 604 can transmit a data flow over the alternate path. For example, the user device 602 can stream content (e.g., music, audio, graphics, etc.) to the wireless subsystem 604 over the alternate path. The content can be presented via the infotainment system (e.g., the content is output through one or more speakers and/or displays).

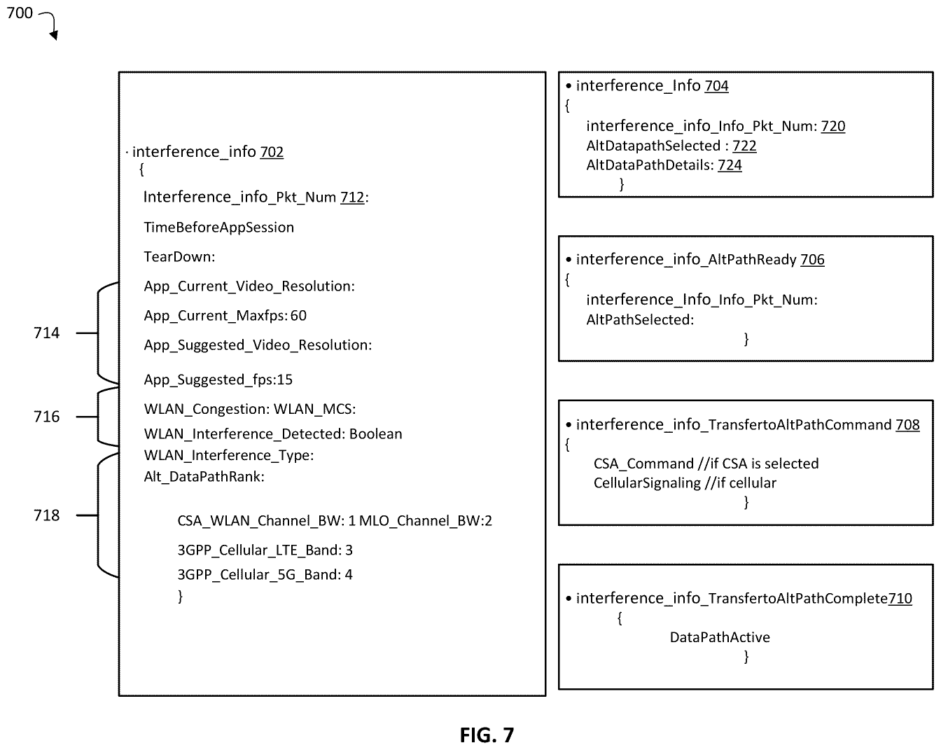

FIG. 7 is an illustration 700 of example messaging for a multi-layer detection system, according to one or more embodiments. The messages can include an interference_info message 702 (e.g., the interference_info message of step 606 above), an interference_ACK message 704 (e.g., the interference_ACK message of step 608 above), an interference_AltPathReady message 706 (e.g., the interference_AltPathReady message of step 610 above), a first interference_TransfertoAltPathCommand message 708 (e.g., the interference_TransfertoAltPathCommand message of step 612 above), and an interference_TransferComplete message 710.

The interference_info message 702 can include an interference packet number (interference_Pkt_Num) 712 that indicates which data packet(s) in a sequence of data packets include the interference information. The interference_info message 702 can further include content information 714 related to the data streaming from the user device to the infotainment system. As illustrated, the content information 714 relates to video content. However, in other instances, in which the content is audio or mixed media content, the content information 714 can relate to audio or mixed media content. The interference_info message 702 can further include interference information 716. Similar to the content information 714, the interference information 716 can include information specific to potential interference to be experienced by the connection between the user device to the infotainment system. The interference_info message 702 can further include alternate path information 718. As indicated above, one or more different alternate paths can be selected for the user device to connect with the infotainment system. Therefore, the user device can provide alternate path information 718 to assist in selecting which alternate path to use. It should be appreciated that the multi-layer detection system can use any/all relevant information, including user device capability, the content information 714, interference information 716, and/or the alternate path information 718 to select an alternate path.

The interference_ACK message 704 can include an interference information packet number (interference_info_Pkt_Num) 720, an identification of a selected alternate path (AltDataPathSelected) 722, and one or more alternate path details (AltDatapathDetails) 724. The alternate path details 724 can include user device configuration information for enabling the user device to transfer from the original communication path to the alternate path.

The interference_AltPathReady message 706 can include information indicating that the user device has used the configuration information and configured the user device to use the selected alternate path to communicate with the AP.

The interference_TransfertoAltPathCommand message 708 can include information, such as control instructions, to transfer communication to the selected alternate path. The interference_TransferComplete message 710 can include information indicating that an alternate path between the user device and the Wi-Fi AP over the selected alternate path is open and/or available.

FIGS. 8-15 describe various alternate paths that can be selected to be used for communication between a user device and an infotainment subsystem. For each of FIGS. 8-15, a user device can communicate with a Wi-Fi AP (or other Wi-Fi interface) of an infotainment subsystem to present content using an infotainment subsystem. The user device can determine that the connection between the user device and the Wi-Fi AP is experiencing interference. In response to the determination, the user device can transmit interference information to the Wi-Fi AP. The Wi-Fi AP can use the interference information to select an alternate path. The Wi-Fi AP and the user device can exchange information to enable the user device to communicate with the Wi-Fi AP over the alternate path. In some instances, the Wi-Fi AP (or other Wi-Fi radio of the infotainment subsystem) can detect the presence of interference and transmit interference information to the user device.

FIG. 8 is an illustration 800 of an example alternate path, according to one or more embodiments. A user device 802 can transmit interference information 804 to a Bluetooth interface 806 of a wireless subsystem 808, e.g., based on determining that the connection between the user device 802 and the wireless subsystem 808 is experiencing interference. The Bluetooth interface 806 can operate in a PHY or data link layer of a network stack associated with the wireless subsystem. The Wi-Fi AP 810 can select an alternate path based on the interference information 804, such as electing to switch from using a first channel 812 to using a second channel 814 for communication between the user device 802 and the infotainment subsystem 816. The Wi-Fi AP 810 can transmit instructions to the user device 802 to switch from using the first channel 812 to using the second channel 814. The Wi-Fi AP 810 can receive an acknowledgement from the user device 802, indicating that the user device 802 is ready to communicate over the second channel 814. The Wi-Fi AP 810 can receive information from the user device 802 over the second channel 814, and the application layer 818 can present content using the infotainment subsystem 816.

As an example, the Wi-Fi AP 810 can transmit a message with the selection of the alternate path to the user device 802 in response to receiving the interference information 804. The Wi-Fi AP 810 can transmit the selection of the alternate path via an interference_AltPathSelected message to the user device 802. The message can include information, such as a channel switch announcement (CSA) exchange information that includes information for changing a communication channel from the first channel 812 to the second channel 814. The information can also include BSS transition management (BTM) exchange information. The BTM can also include information for changing a communication channel from the first channel 812 to the second channel 814. The user device 802 can use the information to adjust one or more communication path parameters and change from using the first channel 812 to communicate with the wireless subsystem 808 to using the second channel 814. As the interference signal is affecting the first channel 812, the user device 802 and the wireless subsystem 808 can communicate over the second channel 814 without interference or with reduced interference. The user device 802 can transmit an acknowledgement (interference_TransferComplete) to the wireless subsystem 808 that the user device is ready to transmit over the second channel 814. The wireless subsystem 808 can receive information from the user device 802 over the second channel 814, and the application layer 818 can present content using the infotainment system.

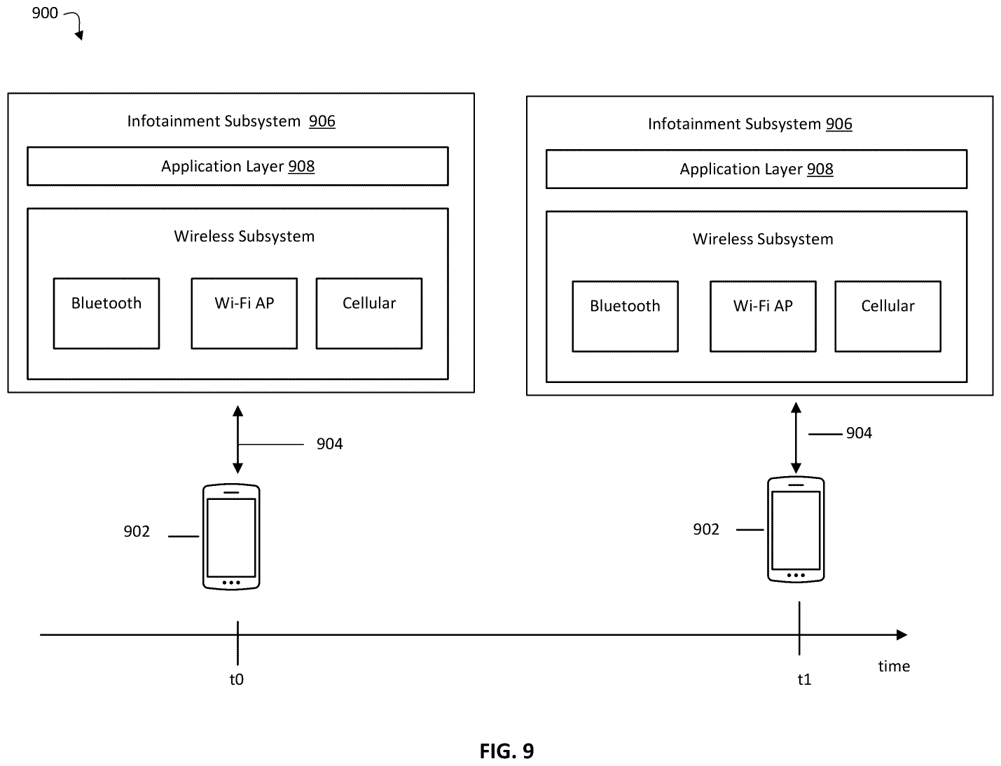

FIG. 9 is an illustration 900 of an alternate path switch back process, according to one or more embodiments. At t0, the user device 902 (e.g., user device 802) can communicate over the second channel 904 (e.g., second channel 814) with the infotainment subsystem 906. In some instances, the user device 902 (e.g., user device 802) can elect to switch back to the first channel (e.g., first channel 812) after switching to the second channel 904 as described in FIG. 8. In other instances, the user device 902 can elect to keep using the second channel 904 as the operating channel.

The user device 902 can further determine whether to switch back to the original communication path (e.g., first channel 812) based on the selected alternate path and various factors, such as cost parameters, power parameters, thermal parameters, and/or data parameters. The user device 902 can evaluate one or more parameters and determine whether to switch back from the second channel 904 to the first channel to communicate with the infotainment subsystem 906. As illustrated in FIG. 9, the user device 902 can determine that the channel switch path for switching from a first channel to the second channel 904 has low cost and no impact on the power and thermal parameters. Based on this determination, the user device 902 can skip further evaluation of the performance of the application layer 908 and whether the user device 902 is within a threshold proximity to an interference zone. Based on determining that the channel switch path has low cost and no impact on the power and thermal parameters, the user device 902 can determine to continue to designate the second channel 904 as the operating channel at t1. In another example, if the user device 902 had determined that the switch from the first channel to the second channel 904 had a high cost, the user device 902 could determine to switch back to communicating over the first channel.

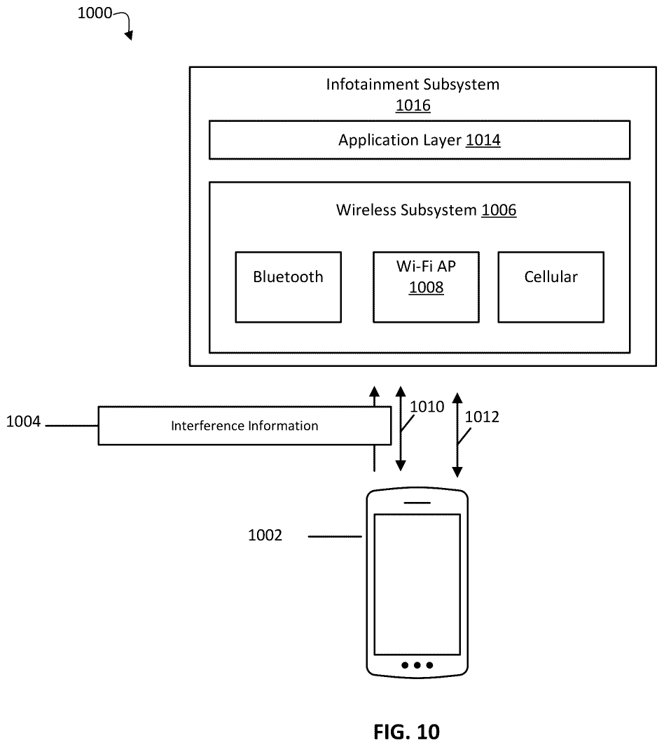

FIG. 10 is an illustration 1000 of an example user device in communication with a wireless subsystem medium, according to one or more embodiments. A user device 1002 can transmit interference information 1004 to a wireless subsystem 1006 based on determining that the connection between the user device 1002 and the wireless subsystem 1006 via the Wi-Fi AP 1008 is experiencing interference. Based on the interference information 1004, the Wi-Fi AP 1008 of the wireless subsystem 1006 can select an alternate path, such as switching from using a first channel 1010 to duplicating data packets over a multi-link operation. For example, the user device 1002 and the wireless subsystem 1006 can originally communicate over a first channel 1010 via the Wi-Fi AP 1008. The Wi-Fi AP 1008 can transmit an interference_AltPathSelected message indicating that the user device 1002 and the wireless subsystem 1006 are to duplicate data packets. The user device 1002 and the wireless subsystem 1006 are to continue to exchange information over the first channel 1010 via the Wi-Fi AP 1008. The user device 1002 and the wireless subsystem 1006 are to also exchange the duplicated information (e.g., duplicated data packets) over a second channel 1012 via the Wi-Fi AP 1008. The wireless subsystem 1006 can receive both the data packets over the first channel 1010 and the duplicated data packets over the second channel 1012. The wireless subsystem 1006 can transmit either of the data packets or duplicated data packets to the application layer 1014, and the application layer 1014 can present content using the infotainment subsystem 1016.

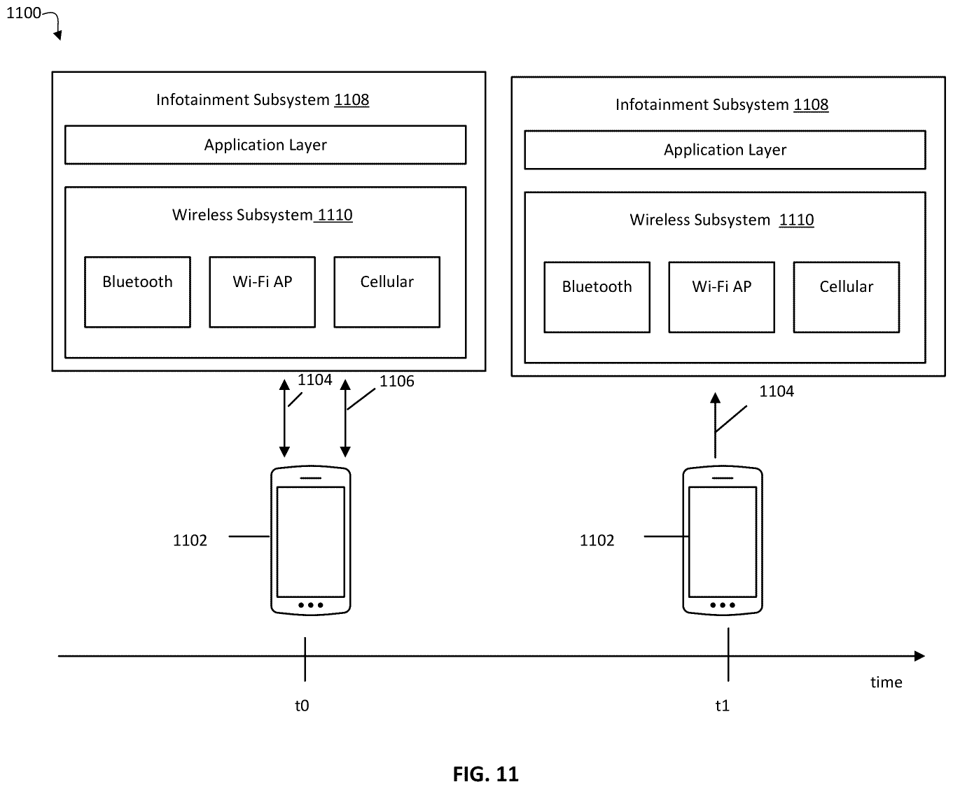

FIG. 11 is an illustration 1100 of an example alternate path switch back process, according to one or more embodiments. At t0, the user device 1102 (e.g., user device 1002) can communicate using the multi-link operation (e.g., over the first channel 1104 and the second channel 1106) with an infotainment subsystem 1108. The first channel 1104 can be the first channel 1010 of FIG. 10, and the second channel 1106 can be the second channel 1012 of FIG. 10. In some instances, the user device 1102 (e.g., user device 1002) can elect to switch back to the first channel after switching to the multi-link operation as described in FIG. 10. In other instances, the user device 902 can elect to continue using the multi-link operation.

The user device 1102 can monitor each of the first channel 1104 and the second channel 1106 for latency issues and data packet loss values (e.g., data packet loss rates). The user device 1102 can further monitor a distance between the user device 1102 and one or more known interference zones. For example, the user device 1102 can access a location service (e.g., a GPS service) and determine a current position of the user device 1102. The user device 1102 can further access a database of known interference zones (or areas) and determine a distance between the current position of the user device 1102 and the edge of one or more known interference zones. The user device 1102 can compare the distance with a threshold distance. As indicated above, the user device 1102 can be in a moving vehicle, and therefore can determine a current distance between the current position of the user device 1102 and the edge of an interference zone with any desired frequency. For example, the user device 1102 can determine the distance to an interference zone boundary periodically, e.g., based on the speed and/or direction of travel. The user device 1102 can compare the current distance to a threshold distance. For example, as a vehicle is approaching an edge of an interference zone, the user device 1102 can determine when it is within the threshold distance of the interference zone. As the vehicle moves away from the edge of the interference zone, the user device 1102 can determine when it is greater than a threshold distance from the edge of the interference zone. The user device 1102 can evaluate the information and determine whether to switch back from the multi-link operation to the first channel 1104.

The user device 1102 can transmit a message to the wireless subsystem 1110, where the message includes the evaluation. If the evaluation indicates that the connection between the user device 1102 and the wireless subsystem 1110 is not experiencing interference, the wireless subsystem 1110 can transmit a message to switch back to using the first channel 1104. If the evaluation indicates that the connection between the user device 1102 and the wireless subsystem 1110 is experiencing interference, the wireless subsystem 1110 can transmit a message to continue with the multi-link operation. In some instances, the absence of a message from the wireless subsystem 1110 to switch from the multi-link operation to the first channel 1104 can indicate that the user device 1102 should continue to use the multi-link operation. As illustrated in FIG. 11, the user device 1102 can transmit a message to the wireless subsystem 1110 to switch back from the multi-link operation to the first channel 1104 based on the evaluation. The user device 1102 and the wireless subsystem 1110 can communicate using the first channel 1104 at t1. It should be appreciated that in other instances, the user device 1102 may transmit a message to continue with the multi-link operation based on the evaluation.

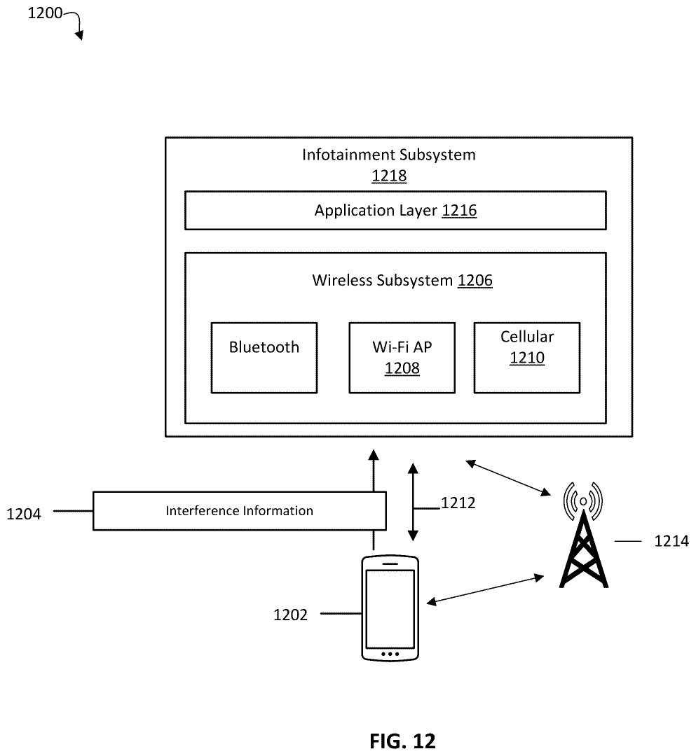

FIG. 12 is an illustration 1200 of an example user device in communication with an AP, according to one or more embodiments. A user device 1202 can transmit interference information 1204 to a Wi-Fi interface (Wi-Fi) 1208 based on determining that the connection between the user device 1202 and the wireless subsystem 1206 is experiencing interference. The Wi-Fi AP 1208 can select an alternate path based on the interference information 1204, such as duplicating data packets and transmitting the duplicate data packets over an alternate link, such as via cellular 1210, (e.g., 4G LTE and/or 5G). For example, the wireless subsystem 1206 can transmit an interference_AltPathSelected message indicating that the user device 1202 and the wireless subsystem 1206 are to continue transmitting data packets over a first channel 1212. The message can further indicate that the user device 1202 and the wireless subsystem 1206 are to duplicate the data packets and transmit the duplicated data packets over a cellular link. For example, the user device 1202 can connect with a base station 1214 using cellular technology. The base station 1214 can connect with a cellular interface (cellular 1210) of the wireless subsystem 1206. The base station 1214 can relay the duplicate data packets between the user device 1202 and the wireless subsystem 1206 using the cellular technology. The application layer 1216 can use the information received from the user device 1202 to present content using an infotainment subsystem 1218.

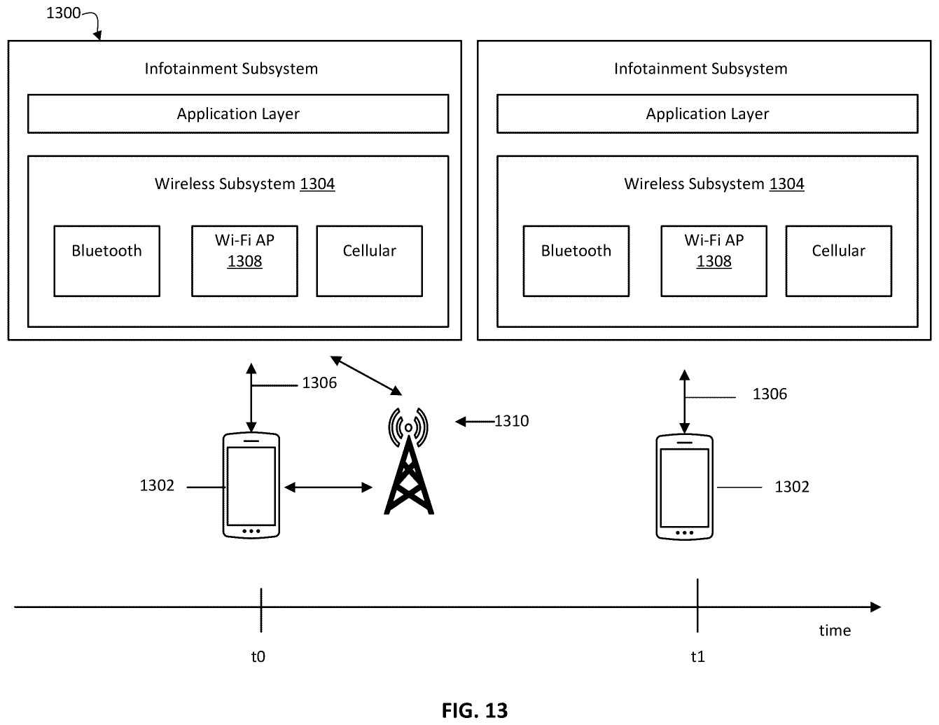

FIG. 13 is an illustration 1300 of an example alternate path switch back process, according to one or more embodiments. At t0, the user device 1302 (e.g., user device 1202) can communicate with the wireless subsystem 1304 (e.g., wireless subsystem 1206) using the first channel 1306 (e.g., first channel 1212) and a base station 1310 (e.g., base station 1214) via cellular technology. In some instances, the user device 1302 can elect to switch back to the first channel 1306 after switching to transmitting data packets over the first channel 1306 and transmitting duplicated data packets using the base station 1310, as described in FIG. 12. In other instances, the user device 1302 can elect to continue to communicate using the first channel 1306 and the base station 1310.

The user device 1302 can monitor communication over each of the first channel 1306 and via the base station 1310 for latency issues and data packet loss. The user device 1302 can determine the latency between the user device 1302 and the wireless subsystem 1304 over the first channel 1306 (e.g., a Wi-Fi link). The user device 1302 can also determine the latency between the user device 1302 and the wireless subsystem 1304 via the cellular communication path using the base station 1310. The user device 1302 can compare the latency between the user device 1302 and the wireless subsystem 1304 using the first channel 1306 to a threshold latency. The user device 1302 can also determine the data packet loss between the user device 1302 and the wireless subsystem 1304 over the first channel 1306. The user device 1302 can compare the data packet loss between the user device 1302 and the wireless subsystem 1304 using the first channel 1306 to a threshold data packet loss.

If the latency between the user device 1302 and the wireless subsystem 1304 over the first channel 1306 is less than the threshold latency, and the data packet loss between the user device 1302 and the wireless subsystem 1304 over the first channel 1306 is less than the threshold data packet loss, the user device 1302 can determine the latency and the data packet loss information indicates that the user device can switch back to using the first channel 1306. If either the latency between the user device 1302 and the wireless subsystem 1304 over the first channel 1306 is greater than the threshold latency, or the data packet loss between the user device 1302 and the wireless subsystem 1304 over the first channel 1306 is greater than the threshold data packet loss, the user device 1302 can determine the latency and the data packet loss information indicates that the user device can continue using the first channel 1306 and the cellular communication path using the base station 1310.

The user device 1302 can further monitor a distance between the user device 1302 and any known interference zones. For example, the user device 1302 can access a location service (e.g., a GPS service) and determine a current position of the user device 1302. The user device 1302 can further access a database of known interference zones (or areas) and determine a distance between the current position of the user device 1302 and the edge of a known interference zone. The user device 1302 can compare the distance with a threshold distance. As indicated above, the user device 1302 can be in a moving vehicle and can determine a current distance between the current position of the user device 1302 and the edge of an interference zone. In some implementations, the frequency of the determination can be influenced by one or more factors, such as the speed of travel, direction of travel, planned route of travel, and/or distance to one or more interference zone boundaries. The user device 1302 can further compare the current distance to the edge of an interference zone to a threshold distance. For example, as a vehicle is approaching an edge of an interference zone, the user device 1302 can determine when the user device is within the threshold distance of the interference zone. As the vehicle moves away from the edge of the interference zone, the user device 1302 can determine when the user device 1302 is greater than a threshold distance from the edge of the interference zone. The user device 1302 can evaluate the information and determine whether to switch back from the multi-link operation to the first channel 1306.

The user device 1302 can evaluate the information and determine whether to switch back from the multi-link operation to the first channel 1306. For example, if the latency and data packet loss evaluation indicates that the network connecting the user device 1302 and the wireless subsystem 1304 is not experiencing interference, and the location evaluation indicates that the user device 1302 is not within a threshold distance of an interference zone, the user device 1302 can determine to switch back using the first channel 1306. If, however, either the latency and data packet loss evaluation indicates that the network connecting the user device 1302 and the wireless subsystem 1304 is experiencing interference, or the location evaluation indicates that the user device 1302 is within a threshold distance of an interference zone, the user device 1302 can determine to continue using the first channel 1306 and the communication path via the base station 1310.

The user device 1302 can transmit a message to the wireless subsystem 1304 that includes its evaluation. If the evaluation indicates that the connection between the user device 1302 and the Wi-Fi AP 1308 is experiencing interference over the first channel 1306, the message can indicate to continue with using the first channel and the communication path via the base station 1310. If, however, the evaluation indicates that the network connecting the user device 1302 and the Wi-Fi AP 1308 is not experiencing interference over the first channel 1306, the message can indicate to switch back to the first channel 1306. In some instances, the absence of a message to switch back to the first channel 1306 can indicate that the user device should continue with using the first channel and the communication path via the base station 1310. As illustrated, in FIG. 13, the user device 1302 can transmit a message switch back to using the first channel 1306 based on the evaluation. The user device 1302 and the Wi-Fi AP 1304 can communicate using the first channel 1306 at t1. It should be appreciated that in other instances, the user device 1302 may transmit a message for the user device 1302 to continue with using the first channel 1306 and the base station 1310 based on the evaluation.

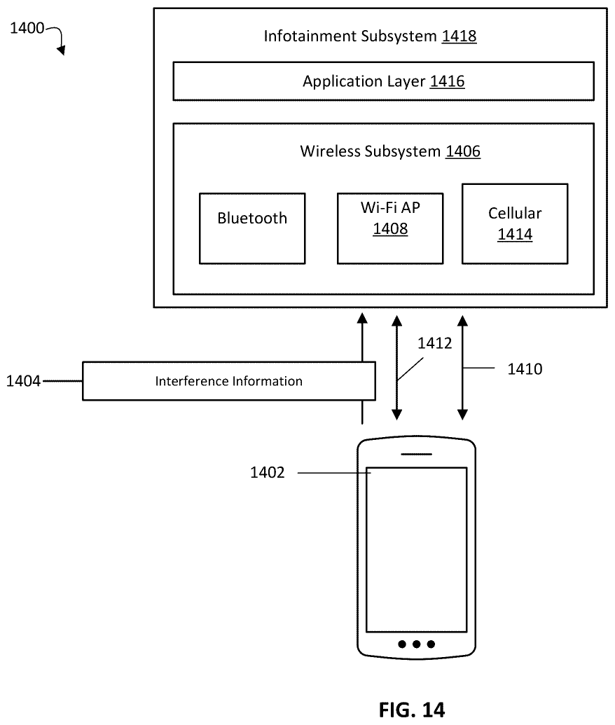

FIG. 14 is an illustration 1400 of an example alternate path, according to one or more embodiments. A user device 1402 can transmit interference information 1404 to a Wi-Fi AP 1408 based on determining that the connection between the user device 1402 and the Wi-Fi AP 1408 is experiencing interference. The Wi-Fi AP 1408 can select an alternate path based on the interference information 1404. The alternate path can include duplicating data packets and transmitting the duplicate data packets over a peer-to-peer cellular connection 1410. A peer-to-peer cellular connection 1410 can be a direct connection between the user device 1402 and the wireless subsystem 1406 (e.g., cellular unit 1414 of the wireless subsystem 1406). For example, the Wi-Fi AP 1408 can transmit a message indicating that the user device 1402 and the Wi-Fi AP 1408 are to continue transmitting data packets over a first channel 1412. The message can further indicate that the user device 1402 and the Wi-Fi AP 1408 are to duplicate the data packets and transmit the duplicated data packets over the peer-to-peer cellular connection 1410. For example, the user device 1402 can communicate with a cellular interface (cellular 1414) of the Wi-Fi AP 1408 for transmitting the duplicated data packets. The user device 1402 and the Wi-Fi AP 1408 can exchange information using the first channel 1412 and the peer-to-peer cellular connection 1410. The application layer 1416 can present content using an infotainment subsystem 1418 based on the information received from the user device 1402.

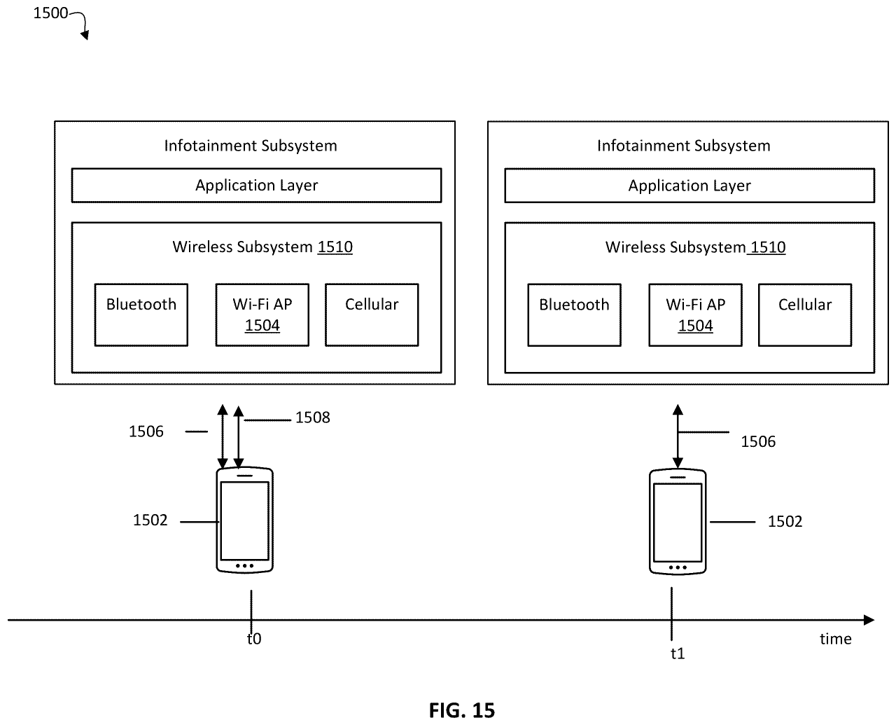

FIG. 15 is an illustration 1500 of an example alternate path switch back process, according to one or more embodiments. At t0, the user device 1502 (e.g., the user device 1402) can communicate with the Wi-Fi AP 1504 (e.g., Wi-Fi AP 1408) using a first channel 1506 (e.g., first channel 1412) and cellular connection 1508 (e.g., peer-to-peer cellular connection 1410). In some instances, the user device 1502 can elect to switch back to the first channel 1506 after switching to using both the cellular connection 1508 and the first channel 1506, as described in FIG. 14. In other instances, the user device 1502 can elect to continue using both the first channel 1506 and the cellular connection 1508.

The user device 1502 can monitor the communication of each of the first channel 1506 and the cellular connection for latency issues and data packet loss. The user device 1502 can determine the latency between the user device 1502 and the Wi-Fi AP 1504 over the first channel 1506 (e.g., a Wi-Fi link). The user device 1502 can also determine the latency between the user device 1502 and the wireless subsystem 1510 over the cellular connection 1508. The user device 1502 can compare the latency between the user device 1502 and the Wi-Fi AP 1504 over the first channel 1506 to a threshold latency. The user device 1502 can also determine the data packet loss between the user device 1502 and the Wi-Fi AP 1504 over the first channel 1506. The user device 1502 can compare the data packet loss between the user device 1502 and the Wi-Fi AP 1504 over the first channel 1506 to a threshold data packet loss.

If the latency between the user device 1502 and the Wi-Fi AP 1504 over the first channel 1506 is less than the threshold latency, and the data packet loss between the user device 1502 and the Wi-Fi AP 1504 over the first channel 1506 is less than the threshold data packet loss, the user device 1502 can determine that there is no interference (or an acceptable amount of interference) and that user device 1502 can switch back to using the first channel 1506. If either the latency between the user device 1502 and the Wi-Fi AP 1504 over the first channel 1506 is greater than the threshold latency, or the data packet loss between the user device 1502 and the Wi-Fi AP 1504 over the first channel 1506 is greater than the threshold data packet loss, the user device 1502 can determine that there is interference and that the user device 1502 can continue to communicate with the wireless subsystem 1510 using the first channel 1506 and the cellular connection 1508.

The user device 1502 can also monitor a distance between the user device 1502 and one or more known interference zones. For example, the user device 1502 can access a location service (e.g., a GPS service) and determine a current position of the user device 1502. The user device 1502 can further access a database of known interference zones (or areas) and determine a distance between the current position of the user device 1502 and the edge of one or more known interference zones. The user device 1502 can compare the distance with a threshold distance. As indicated above, the user device 1502 can be in a moving vehicle, and therefore can determine a current distance between the current position of the user device 1502 and the edge of an interference zone. In some implementations, the frequency with which the current distance is determined can be influenced by one or more factors, such as the speed of travel, direction of travel, planned route of travel, and/or distance to one or more interference zone boundaries. The user device 1502 can further compare the current distance to a threshold distance. For example, as a vehicle is approaching an edge of an interference zone, the user device 1502 can determine when the user device 1502 is within the threshold distance of the interference zone. As the vehicle moves away from the edge of the interference zone, the user device 1502 can determine when the user device 1502 is greater than a threshold distance from the edge of the interference zone.

The user device 1502 can evaluate the information and determine whether to switch back from the multi-link operation to the first channel 1506. For example, if the latency and data packet loss evaluation indicates that the connection between the user device 1502 and the Wi-Fi AP 1504 is not experiencing interference, and the location evaluation indicates that the user device 1502 is not within a threshold distance of an interference zone, the user device 1502 can determine to switch back to using the first channel 1506. If, however, either the latency and data packet loss evaluation indicates that the connection between the user device 1502 and the Wi-Fi AP 1504 is experiencing interference, or the location evaluation indicates that the user device 1502 is within a threshold distance of an interference zone, the user device 1502 can determine to continue using the first channel 1506 and cellular connection 1508.

The user device 1502 can transmit a message to the Wi-Fi AP 1504 that includes its evaluation. If the evaluation indicates that the connection between the user device 1502 and the Wi-Fi AP 1504 is experiencing interference over the first channel 1506, the message can indicate to continue with using the first channel and cellular connection 1508. If, however, the evaluation indicates that the connection between the user device 1502 and the Wi-Fi AP 1504 is not experiencing interference over the first channel 1506, the message can indicate to switch back to the first channel 1506. In some instances, the absence of a message to switch back to the first channel 1506 can indicate that the user device should continue with using the first channel and the cellular connection 1508. As illustrated in FIG. 15, the user device 1502 can transmit a message to switch back to using the first channel 1506 based on the evaluation. The user device 1502 and the Wi-Fi AP 1504 can communicate using the first channel 1506 at t1. It should be appreciated that in other instances, the user device 1502 may transmit a message for the user device 1502 to continue with using the first channel 1506 and the cellular connection 1508 based on the evaluation.

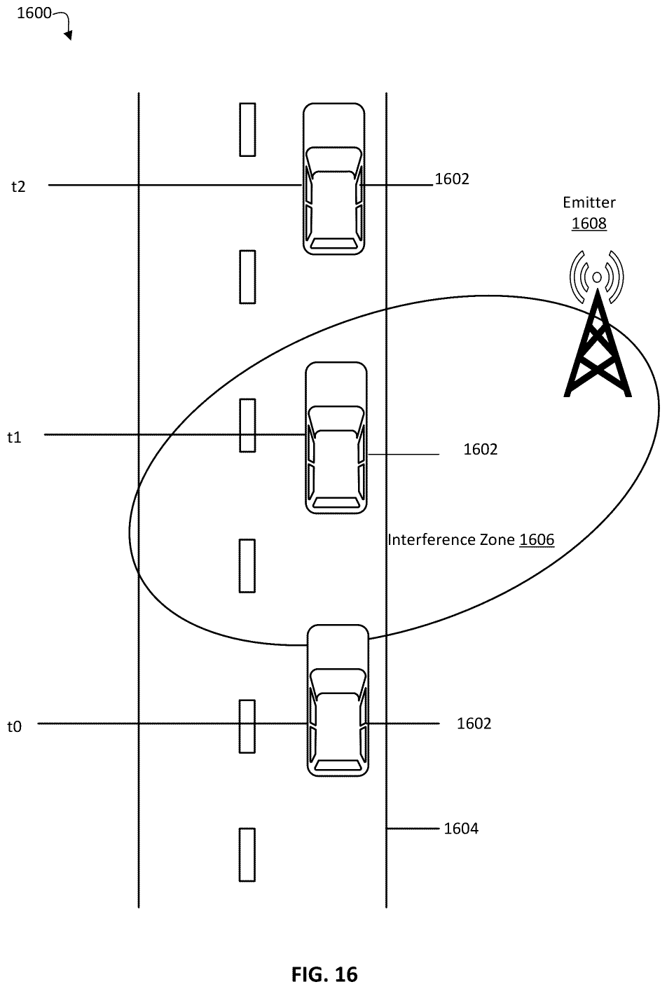

FIG. 16 is an illustration 1600 of an example of different stages of a vehicle encountering an interference signal, according to one or more embodiments. FIG. 16 illustrates a vehicle 1602 on a roadway 1604 entering an interference zone 1606 at t0. The interference zone 1606 can be caused by an emitter 1608 broadcasting using a same or overlapping channel (or frequencies) as a user device and the vehicle's infotainment system, and in proximity to the roadway 1604. The emitter 1608 can include, for example, a traffic camera that is emitting a signal that can cause interference in the wireless connection between the user device and the infotainment system. In other instances, the interference zone 1606 can be caused by one or more other vehicles that include devices communicating on the same channel (or overlapping channel) as the channel used by the user device and the infotainment system. The interference zone 1606 can also be caused by a signal source emitting radio frequency (RF) energy, e.g., that the user device or infotainment system cannot decode. The interference can be any emission that reduces the ability for the user device and infotainment system to communicate. It should be appreciated that other examples of interference zone causes can be contemplated by a person of ordinary skill in the art.

The vehicle 1602 can include an infotainment system that includes software (e.g., Apple CarPlay, Android Auto, Mirror Link, or other similar software) for providing access to the functionality of a user device. The driver can have a user device (e.g., a smartphone, a laptop, a tablet, a wearable, etc.) that is in wireless communication with the infotainment system. The software can be used to facilitate receiving information from the user device over the wireless communication path. The software can further be used to display information, including application icons, on an in-dash display of the infotainment system. For example, the software can cause an in-dash display to present a navigation application icon, a music streaming service application icon, a telephone application icon, a podcast icon, and a messaging application icon. Any icon or set of icons corresponding to functionality available on a user device can be presented on the in-dash display, e.g., to access the functionality through a vehicle system. The software can further act as a controller for the applications operating on the user device. For example, a driver can use the in-dash display to select (e.g., using a touchscreen or manual buttons) to access a music streaming service icon. The software can receive the input from the in-dash display and cause the music streaming service on the user device to initialize. The driver can further use the display to make (or receive) a phone call through the infotainment system without interacting directly with the user device.

As the vehicle 1602 is entering the interference zone 1606 it is possible that the connection between the user device and the infotainment system may begin to experience interference (e.g., loss of data packets, latency issues). Therefore, if the communication path between the user device and the infotainment system is not adjusted, the driver may begin to notice a diminishment in the quality of the user device data presented over the infotainment system.

The multi-layer detection system can include a combination of hardware and software for receiving information from the user device and providing the information to the infotainment system.

The infotainment system, and the user device can monitor information, such as Wi-Fi link quality monitoring (LQM) information, transmission control protocol (TCP) information, keep-alive time outs information, and known interference zone information. The multi-layer detection system can use combinations of the information to determine whether there is an indication that the connection between the user device and the infotainment system is experiencing interference. In the event that the multi-layer detection system determines that the connection is experiencing interference, it can adjust one or more communication path parameters between the user device and the infotainment system to mitigate or reduce any interference effects.

At t1, the vehicle 1602 can be in the interference zone, and the user device and infotainment system can communicate using the one or more adjusted communication path parameters. The driver may not notice a diminishment in the experience, even in the interference zone. It should be appreciated that the detection of the interference signal and the adjustment of the one or more communication path parameters are performed in a background process and the driver does not need to be made aware or enter any inputs into the user device or infotainment system. It should be appreciated that as the driver drives along the roadway 1604 and in the interference zone 1606, the multi-layer detection system can continue to monitor information to determine whether the user device and infotainment system are still in the interference zone.

At t2, the vehicle 1602 has moved out of the interference zone 1606. The multi-layer detection system can determine that the user device and the infotainment system are out of the interference zone 1606. The multi-layer detection system can then determine whether the user device and the infotainment system should continue to communicate using the adjusted communication path or switch back to the original communication path. For example, if the user device and the infotainment system were communicating over a first channel and changed to a second channel, the multi-layer detection system can determine whether the user device and the infotainment system should continue using the second channel or switch back to the first channel.

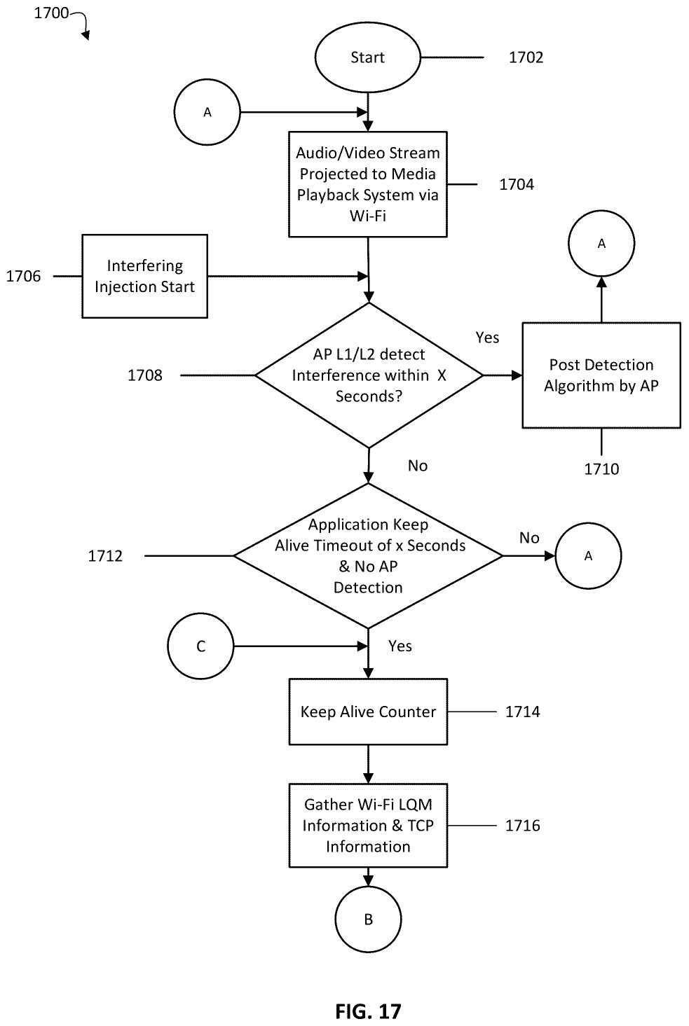

FIG. 17 is an example process flow 1700 for detecting an interference signal, according to one or more embodiments. At 1702, a media playback system (e.g., vehicle infotainment system, in-vehicle system) can initialize software that can present content received from a user device. For example, the user device can connect with a media playback system using a Wi-Fi connection over a first channel. The media playback system can include software for presenting content from the user device via the media playback system.

At 1704, a user device can stream audio and/or video content using a media playback system. For example, a music streaming service can be installed on a user device. The media playback system may include software to permit the music streaming service to output music using the media playback system's speakers.

At 1706, the user device and the media playback system can begin to experience the injection (or impact) of an interference signal. The interference can be caused by, for example, an emitter (e.g., a traffic camera, radio tower, radar, etc.) transmitting on one or more frequencies that correspond to the first channel. Another potential cause of interference can be one or more other devices communicating, in proximity to the vehicle, over one or more frequencies that correspond to the first channel.

At 1708, a wireless subsystem associated with a media playback system can determine whether it can detect interference within a time interval. The wireless subsystem can monitor for one or more Wi-Fi frame and/or subframe types at the L1/L2 layers of a network stack. For example, the wireless subsystem can start a first timer and monitor for one or more Wi-Fi frame and/or subframe types at a PHY and/or a MAC of the network stack. In some instances, the signals that operate near the same set of frequencies as frequencies corresponding to the first channel can be identified by Wi-Fi frame or subframe type. For example, some Wi-Fi frame or subframe types can be associated with a particular set of frequencies, such as the set of frequencies used corresponding to the first channel. Therefore, by identifying a Wi-Fi frame or subframe type that is associated with the set of frequencies corresponding to the first channel, the wireless subsystem can detect likely interference signals.

If, at 1708, the wireless subsystem detected an interference signal at either layer 1 or layer 2 of the wireless subsystem prior to the expiration of the first timer (or within x seconds, where x can include one second, two seconds, five seconds, or other appropriate time interval), the wireless subsystem can execute a post detection algorithm at 1710. The post detection algorithm can include determining one or more available alternate paths. The determination can be based on any/all of the capabilities of the user device, the content streaming on the media playback system, the detected interference signals, and/or any other appropriate information. The wireless subsystem can exchange information to enable the user device to adjust the communication path parameters and communicate with the wireless subsystem over the alternate path.

If at 1708, the wireless subsystem does detect an interference signal, the wireless subsystem can communicate to the user device that it did not detect signal interference prior to expiration of the first timer. The user device can determine whether there are any keep alive timeouts occurring in the application layer of the user device at 1712.

If, at 1712, the user device does not detect any keep alive time outs (e.g., for a duration of x seconds, where x second can include one second, two seconds, five seconds, or other appropriate time interval) in the user device application layer, and the wireless subsystem does not detect an interference signal at 1708, the process can proceed to operation 1704. If, however, at 1712, the user device detects keep alive time outs in the user device application layer, the user device can start a second timer (e.g., a keep alive timer) at 1714. The user device can further start a counter to determine the number of keep alive timeouts that occur, e.g. within a predetermined period of time.

At 1716, the user device can begin monitoring LQM information and TCP information. For example, the user device can monitor LQM information at the MAC/PHY. Furthermore, the user device can monitor a number of TCP retransmissions at the transport layer. The process can then proceed to step 1702 of FIG. 17.

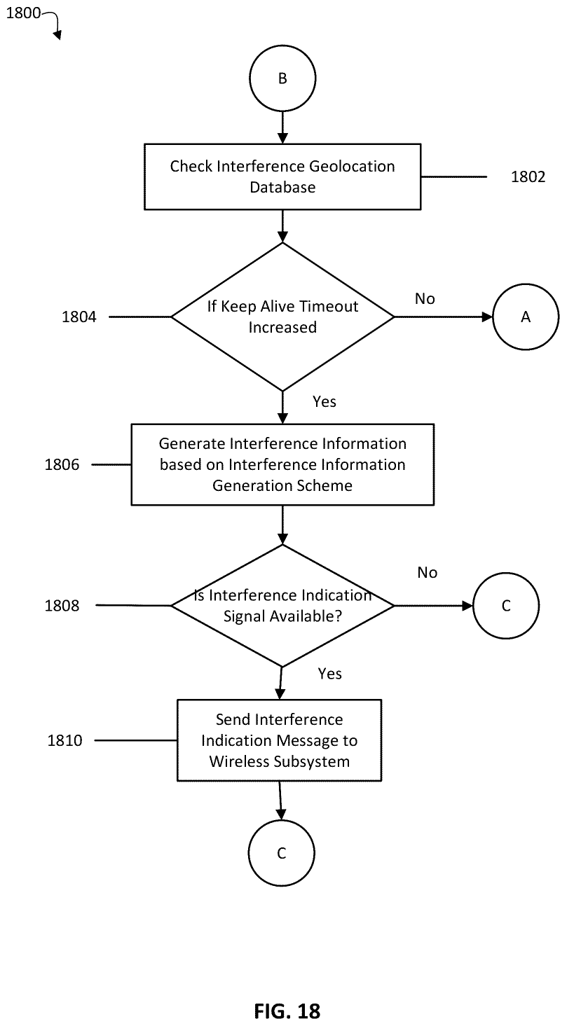

FIG. 18 is a process flow 1800 for detecting an interference signal, according to one or more embodiments. At 1802, the user device can access a database of known interference zones (or areas). The user device can further access a location service to determine whether the user device is within a threshold distance of any known interference zones.

At 1804, the user device can use a keep alive counter to determine the number of keep alive timeouts that occur after the expiration of the first timer (e.g., step 1708). If keep alive timeouts continue to occur, this can be an indication that the connection between the user device and the wireless subsystem is experiencing interference. If the keep alive timeouts stop occurring, this can be an indication that the connection between the user device and the Wi-Fi AP is no longer experiencing interference.

At 1806, the user device can generate interference information that can include an indication that the connection between the user device and the wireless subsystem is experiencing interference. The user device can further transmit the interference information to the wireless subsystem.

At 1808, the user device can determine whether the interference indication signal is being transmitted after a threshold time interval (e.g., “Is the interference information being transmitted after 5 seconds?”). If the interference information is no longer being transmitted after a threshold time interval, the process proceeds to step 1714 of FIG. 17. If the interference information is being transmitted after the threshold time interval, the process proceeds to step 1810.

At 1810, the user device can transmit the interference information to the wireless subsystem. In some instances, the user device can transmit the interference information using a different transmission protocol than the transmission protocol used to transmit content data for presenting on a media playback system. For example, the user device can transmit the content data to the wireless subsystem using Wi-Fi. However, the interference may be making Wi-Fi unreliable. Therefore, the user device can switch to using another transmission protocol (e.g., Bluetooth, NFC, UWB, cellular, etc.) to transmit the interference indication message. After the user device transmits the interference information to the wireless subsystem, the process can proceed to step 1714 of FIG. 17.

Upon receipt of the interference indication message, the user device and the wireless subsystem can exchange information to adjust the communication path between the user device and the wireless subsystem as described with respect to FIGS. 8-15 above.

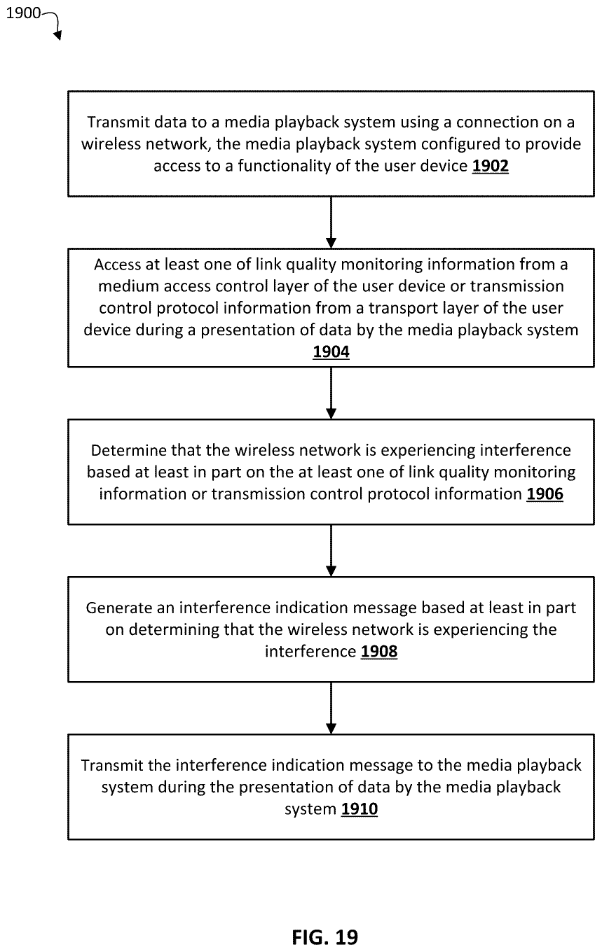

FIG. 19 is a process flow 1900 for transmitting interference information, according to one or more embodiments. At 1902, the method can include a user device (e.g., a laptop, smartphone, wearable, etc.) transmitting data to a media playback system using a wireless connection. The media playback system can be configured to provide access to a functionality of the user device. For example, a media playback system can access a streaming service on the user device and present audio and/or visual content on the media playback system.

At 1904, the method can include the user device accessing at least one of link quality monitoring (LQM) information from a medium access control (MAC) layer of the user device or transmission control protocol information from a transport layer of the user device during a presentation of the data by the media playback system.

The user device can further access interference zone information from a database of known interference zones (or areas). The user device can further compare the locations of one or more known interference zones to the user device's location based on accessing a location service. The interference zone information can indicate that the user is within a threshold distance of a known interference zone. The interference zone information and location information can be accessed during the presentation of the data by the media playback system.

At 1906, the method can include the user device determining that the wireless network is experiencing interference based at least in part on the at least one of link quality monitoring information (LQM) or transmission control protocol (TCP) information.

At 1908, the method can include the user device generating interference information based at least in part on determining that the wireless network is experiencing the interference. The user device can transmit a message that includes the interference information. The interference information can include any/all of content information, interference characteristics, and alternate path information.

At 1910, the method can include transmitting the interference information to the media playback system during the presentation of data by the media playback system. For example, the message can be transmitted to a wireless subsystem of the media playback system. In some embodiments, the user device can select a second transmission protocol (such as Bluetooth, NFC, UWB, cellular, etc.). The user device can further transmit the message to the media playback system using the second transmission protocol.

The user device can further receive, from the media playback system, configuration information for switching from using the first communication path to using a second communication path (e.g., additional Wi-Fi channel, cellular technology, peer-to-peer technology, etc.). The user device can further adjust one or more communication parameters to switch from the first communication path to the second communication path. For example, the first communication path can correspond to using a first channel and the second communication path can correspond to using both the first channel and a second channel.

The user device can further determine a first data packet loss value (e.g., data packet loss rate) corresponding to the first channel and a second data packet loss value corresponding to the second channel. The user device can compare the first data packet loss value corresponding to the first channel and the second data packet loss value at the second channel. The user device can determine whether to switch back to the first communication path based at least in part on comparing the first data packet loss value corresponding to the first channel and the second data packet loss corresponding to the second channel.

Although specific embodiments have been described, it will be appreciated that embodiments may include all modifications and equivalents within the scope of the following claims.

As described above, one aspect of the present technology is the gathering and use of data available from specific and legitimate sources to improve the delivery of messages from one device to one or more devices. The present disclosure contemplates that in some instances, this gathered data may include personal information data that uniquely identifies or may be used to identify a specific person. Such personal information data may include demographic data, location-based data, online identifiers, telephone numbers, email addresses, home addresses, date of birth, or any other personal information.

The present disclosure recognizes that the use of such personal information data, in the present technology, may be used to the benefit of users. For example, the personal information data may be used to deliver a command from a user profile on a computing device to one or more computing devices. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk may be minimized by limiting the collection of data and deleting data once it is no longer needed. In addition, and when applicable, including in certain health related applications, data de-identification may be used to protect a user's privacy. De-identification may be facilitated, when appropriate, by removing identifiers, controlling the amount or specificity of data stored (e.g., collecting streaming data without collecting account information), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments may also be implemented without the need for accessing such personal information data. That is, the various embodiments of the present technology are not rendered inoperable due to the lack of all or a portion of such personal information data. For example, content may be selected and delivered to users based on aggregated non-personal information data or a bare minimum amount of personal information, such as the content being handled only on the user's device or other non-personal information available to the content delivery services.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein may be implemented on the same processor or different processors in any combination. Accordingly, where components or modules are described as being configured to perform certain operations, such configuration may be accomplished, e.g., by designing electronic circuits to perform the operation, by programming programmable electronic circuits (such as microprocessors) to perform the operation, or any combination thereof. Processes may communicate using a variety of techniques, including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments may be utilized in any number of environments and applications beyond those described herein without departing from the broader spirit and scope of the specification. The specification and drawings are, accordingly, to be regarded as illustrative rather than restrictive.

What is claimed is:

1. A method, comprising:
transmitting, by a user device, data to a media playback system using a connection on a wireless network, the media playback system configured to provide access to a functionality of the user device;
accessing, by the user device, at least one of link quality monitoring information from a medium access control layer of the user device or transmission control protocol information from a transport layer of the user device during a presentation of data by the media playback system;
determining, by the user device, that the wireless network is experiencing interference based at least in part on the at least one of link quality monitoring information or transmission control protocol information;
generating, by the user device, interference information based at least in part on determining that the wireless network is experiencing the interference; and
transmitting, by the user device, the interference information to the media playback system during the presentation of data by the media playback system.

2. The method of claim 1, wherein the method further comprises:
accessing location information indicating that the user device is within a threshold distance of a known interference zone,
wherein the determination that the wireless network is experiencing the interference is based at least in part on the user device being within a threshold distance of a known interference zone.

3. The method of claim 1, wherein the user device transmits data to the media playback system using a first communication path, and wherein the method further comprises:
receiving, from the media playback system, configuration information for switching from using the first communication path to using a second communication path; and
adjusting one or more communication parameters to switch from the first communication path to the second communication path.

4. The method of claim 3, wherein the first communication path corresponds to a first channel and the second communication path corresponds to a second channel, different from the first channel.

5. The method of claim 3, wherein the first communication path corresponds to a first channel and the second communication path corresponds to the first channel and a second channel.

6. The method of claim 5, wherein the method further comprises:
determining a first data packet loss value associated with the first channel and a second data packet loss value associated with the second channel;
comparing the first data packet loss value at the first channel and the second data packet loss value at the second channel; and
determining to switch back to the first communication path based at least in part on comparing the first data packet loss value at the first channel and the second data packet loss value at the second channel.

7. The method of claim 1, wherein the connection comprises a Wi-Fi connection, and wherein the method further comprises:
selecting, responsive to determining that the wireless network is experiencing the interference, a second connection for transmitting the interference information to the media playback system.

8. A user device, comprising:
one or more processors; and
one or more computer-readable media including instructions that, when executed by the one or more processors, cause the user device to:
transmit data to a media playback system using a connection on a wireless network, the media playback system configured to provide access to a functionality of the user device;
access at least one of link quality monitoring information from a medium access control layer of the user device or transmission control protocol information from a transport layer of the user device during a presentation of data by the media playback system;
determine that the wireless network is experiencing interference based at least in part on the at least one of link quality monitoring information or transmission control protocol information;
generate interference information based at least in part on determining that the wireless network is experiencing the interference; and
transmit the interference information to the media playback system during the presentation of data by the media playback system.

9. The user device of claim 8, wherein the instructions that, when executed by the processor, further cause the processor to:
access location information indicating that the user device is within a threshold distance of a known interference zone,
wherein the determination that the wireless network is experiencing the interference is based at least in part on the user device being within a threshold distance of a known interference zone.

10. The user device of claim 8, wherein the user device transmits the data to the media playback system using a first communication path, and wherein the instructions that, when executed by the processor, further cause the processor to:
receive, from the media playback system, configuration information for switching from using the first communication path to using a second communication path; and
adjust one or more communication parameters to switch from the first communication path to the second communication path.

11. The user device of claim 10, wherein the first communication path corresponds to a first channel and the second communication path corresponds to a second channel, different from the first channel.

12. The user device of claim 10, wherein the first communication path corresponds to a first channel and the second communication path corresponds to the first channel and a second channel.

13. The user device of claim 12, wherein the instructions that, when executed by the processor, further cause the processor to:
determine a first data packet loss value associated with the first channel and a second data packet loss value associated with the second channel;
compare the first data packet loss value at the first channel and the second data packet loss value at the second channel; and
determine to switch back to the first communication path based at least in part on comparing the first data packet loss value at the first channel and the second data packet loss value at the second channel.

14. The user device of claim 8, wherein Wi-Fi is first transmission control protocol, and wherein the instructions that, when executed by the processor, further cause the processor to:
select, responsive to determining that the wireless network is experiencing the interference, a second connection for transmitting the interference information to the media playback system.

15. One or more non-transitory computer-readable media including stored thereon a sequence of instructions that, when executed, causes one or more processors to:
transmit data to a media playback system using a connection on a wireless network, the media playback system configured to provide access to a functionality of the user device;
access at least one of link quality monitoring information from a medium access control layer of the user device or transmission control protocol information from a transport layer of the user device during a presentation of data by the media playback system;
determine that the wireless network is experiencing interference based at least in part on the at least one of link quality monitoring information or transmission control protocol information;
generate interference information based at least in part on determining that the wireless network is experiencing the interference; and
transmit the interference information to the media playback system during the presentation of data by the media playback system.

16. The one or more non-transitory computer-readable media of claim 15, wherein the instructions that, when executed, further cause the one or more processors to:
access location information indicating that the user device is within a threshold distance of a known interference zone,
wherein the determination that the wireless network is experiencing the interference is based at least in part on the user device being within a threshold distance of a known interference zone.

17. The one or more non-transitory computer-readable media of claim 15, wherein the user device transmits the data to the media playback system using a first communication path, and wherein the instructions that, when executed, further cause the one or more processors to:
receive, from the media playback system, configuration information for switching from using the first communication path to using a second communication path; and
adjust one or more communication parameters to switch from the first communication path to the second communication path.

18. The one or more non-transitory computer-readable media of claim 17, wherein the first communication path corresponds to a first channel and the second communication path corresponds to a second channel, different from the first channel.

19. The one or more non-transitory computer-readable media of claim 17, wherein the first communication path corresponds to a first channel and the second communication path corresponds to the first channel and a second channel.

20. The one or more non-transitory computer-readable media of claim 19, wherein the instructions that, when executed, further cause the one or more processors to:
determine a first data packet loss value associated with the first channel and a second data packet loss value associated with the second channel;
compare the first data packet loss value at the first channel and the second data packet loss value at the second channel; and
determine to switch back to the first communication path based at least in part on comparing the first data packet loss value at the first channel and the second data packet loss value at the second channel.
